(19) United States
(12) Patent Application Publication
(10) Pub. No.: US 2008/0231234 A1
(43) Pub. Date: Sep. 25, 2008

(54) Pull-cord lighting device

(76) Inventor: Pat Y. Mah, Kowloon (HK)

Correspondence Address: Curtis L. Harrington;Suite 250, 6300 State Universtiy Drive, Long Beach, CA, 90815, US

(21) Appl. No.: 11/728,290

(22) Filed: Mar. 22, 2007

(51) Int. Cl. H02J 7/02; H02J 7/14

(52) U.S. Cl. 320/138

(57) ABSTRACT

A manually generatable lighting device utilizes a pull cord, which is mechanically linked to a motor, to charge a power pack for on-demand illumination of at least one light-emitting diode. The lighting device employs circuitry which enables its use as continuous light source, a night light which illuminates automatically in low-light conditions, or an emergency light which illuminates automatically during power failure. The lighting device includes a power plug and may be stored or illuminated portably or as plugged into a power outlet. Built-in charging circuitry allows electrical recharging of the power pack to a maximum of 4 hours of usage, although the pull cord mechanism extends the possible usage time because it allows the power pack to be manually recharged at any time regardless of the level of stored charge available in the power pack. The lighting device requires only minimal effort to achieve maximum brightness, and two complete actuations of the pull cord can achieve maximum charge.

### FIELD OF THE INVENTION

The present invention relates to improved technology in the field of reliable lighting sources and more particularly to a rechargeable lighting device which may be charged using an AC power outlet or which may be hand-generated, and which is engineered for use as any one of a flashlight, a continuously burning night light, or a self-activating emergency light which illuminates during periods of power failure.

### BACKGROUND OF THE INVENTION

Generation of light via a portable lighting product such as a flashlight is a well known expedient in which a tubular body is fitted with a number of series-connected batteries. The main disadvantages of lighting products with this conventional configuration are that (1) non-rechargeable batteries must be replaced regularly, and (2) rechargeable batteries must be recharged regularly, possibly using a separate charging apparatus, and even some rechargeable batteries require replacement over time, and the flashlight does not work when the batteries fail. In either case, replacement and/or recharging of batteries is expensive, time-consuming, and generally requires a considerable degree of forethought, especially where a separate charging apparatus is necessary.

Absent regular usage of a portable lighting product, an emergency need for lighting is often accompanied by the discovery that the batteries are weak, corroded, or dead. Moreover, the time required to replace or recharge weak or dead batteries may be too protracted to satisfy the immediate need to have a functioning light in hand.

With respect to efficiency, the majority of portable lighting products fail because they are generally incandescent (heated filament) and are therefore poor at conserving energy usage per unit of illumination. Although a number of generator-type light products are available, most require considerable hand-crank input to effect any significant light output over time. Hand cranks are easily broken because the protrude from the flashlight. As a result, lighting intended for emergency usage can fall short of a need at the most critical moment.

For example, most lighting products that function as continuously burning night lights will go off in the event of a power failure. During a power failure, flashlights are not always readily available. When greater emergencies accompany power failures, the ability to acquire and use lighting products is diminished. In recent years, some flashlights have the ability to charge and be supported from an outlet. However in an emergency the charging flashlight does not illuminate and does not make itself useful or automatically available in the darkness. In addition, if the batteries are defective from being left in the charging position for a long period of time, the flashlight is useless even if it is located under emergency circumstances.

Self-activating emergency lights can also be problematic in that they are not portable, require a significant installation cost and trouble, including the extension of an AC mains outlet, a tray for supporting a battery weighing from 40 to 60 pounds, and significant maintenance to insure that the system will always be available. Self-activating emergency lights provide good illumination for a limited period of time, usually a few hours, ideally under the assumption that building occupants will be able to evacuate the premises. However in greater disasters, occupants may be trapped for long periods. Further, occupants may be able to leave the areas which are under emergency illumination only to be forced to move through areas in which there is no emergency illumination or in which the emergency illumination is damaged or depleted.

What is therefore needed is a rechargeable lighting device which can be stored long term in a position to function either as an area illumination device continuously, or as an energy light to activate upon power failure of the AC mains, and in either event function as an emergency light upon power failure. Further a lighting system is needed in which lights can be portable, and taken with the user through areas without lighting. The lighting should be power replenishable by the user, either in place or as a portable light. The needed light should remain charged automatically, operate without power source maintenance, and continue to operate indefinitely upon power failure.

### SUMMARY OF THE INVENTION

The lighting device of the present invention is a self contained flashlight which can be used as any one of (1) a portable flashlight, (2) a night light, or (3) an emergency light which self-activates during periods of power failure, and (4) a renewable light which can be manually powered indefinitely. The device may preferably include a power pack which may include rechargeable batteries, a capacitor, or both. Where a rechargeable battery is used in conjunction with either an incandescent light or a series of bright light emitting diodes (high power output), the power pack may be charged for up to approximately four hours of use by plugging the device into an AC power outlet using an attached plug. Where the power pack is a capacitor, and where a single light emitting diode is used, the charge on the capacitor will exponentially decay for several hours before being completely depleted. The user may be permitted to switch between the high power output mode and the low power energy conserving mode. An attached plug will optimally be a folding plug which can be stored during portable use, but which will provide support and an awaiting emergency lighting position while connected to the AC mains. The direction of fold can be from either the front or back end of the device.

In addition to its compatibility with standard AC power outlets, the lighting device may be charged by manual means, yielding a usage time which can vary from between a few minutes up to 4 hours, depending on the input. Manual charging can be achieved by pulling a cord on the device using an attached handle. This can be accomplished either while the device is seated in a power outlet or where it is desirable to use the device portably. With a single light emitting diode output, two pulls on the cord can provide a full charge. Ideally, the folding plug should not be collapsible directly toward the lighted end of the device especially where the lighting device is to be downwardly directed to energize in the power failure condition. In this case the cord can be pulled to charge the batteries while the device is seated in a power outlet without unseating the device from the outlet unintentionally.

The lighting device of the present invention may have a sliding switch which allows a user to select between four settings: OFF, ON, NIGHT LIGHT MODE, and EMERGENCY MODE. Regardless of what setting a user selects, the device will pull and store charge to maximum charge storage capacity anytime it is plugged into a working AC power outlet.

In the night light mode, the lighting device may use a photo sensitive device and relay circuitry to ensure that the light will be off while the room is naturally lighted during the day, and that as a room darkens, the light will illuminate. As long as the device remains plugged into an AC outlet, it can function as a night light throughout the nighttime hours. Where the device is not plugged into an outlet, however, its ability to function will be limited by the power stored. Further, and unlike most conventionally available night lights, the device can be disconnected from the wall outlet and can be used as a portable light. As soon as the device is replaced in the outlet, it will begin recharging toward full capacity. Additionally, the device can be recharged by hand, as described above, where it cannot be replaced in an AC outlet or where a longer usage time is needed.

In the power failure mode, the lighting device may use a current detector and related circuitry to actuate the device. However, the lighting device can be recharged by hand, as described above, and can be repeatedly recharged by hand to provide illumination indefinitely.

### BRIEF DESCRIPTION OF THE DRAWINGS

The invention, its configuration, construction, and operation will be best further described in the following detailed description, taken in conjunction with the accompanying drawings in which:

FIG. 1 is a perspective view from the front end of the lighting device of the present invention;

FIG. 2 is a view of the lighting device of FIG. 1 as plugged into a power outlet near a corner where it may advantageously provide low wall and floor illumination;

FIG. 3 is an exploded view of the lighting device illustrated in FIGS. 1 and 2; front view of the assembled lighting device seen in FIG. 2; and

FIG. 4 is a schematic block diagram illustrating the components and circuitry of the lighting device.

### DETAILED DESCRIPTION OF THE PREFERRED EMBODIMENT

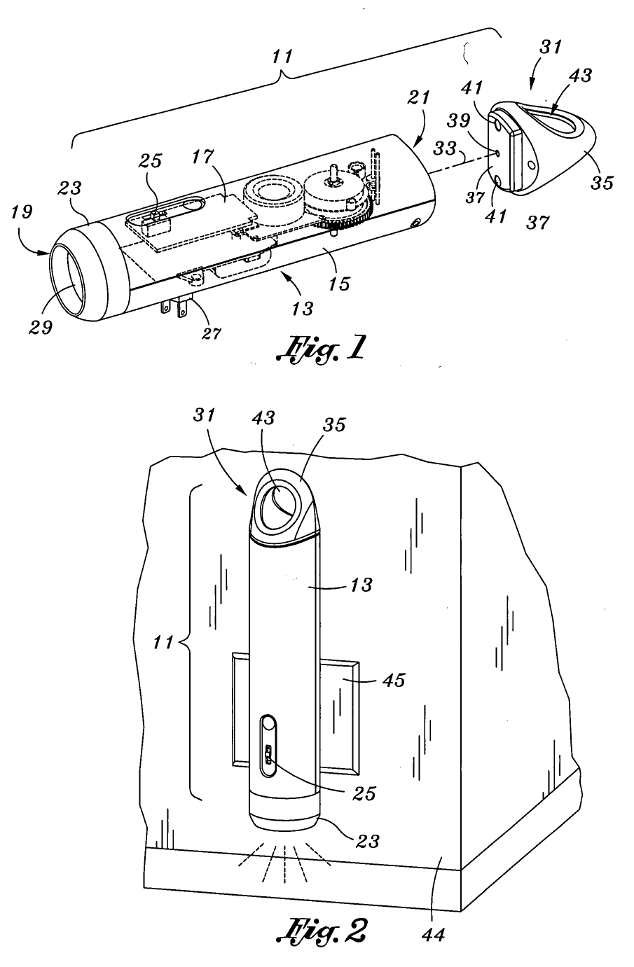

The description and operation of the invention will be best initiated with reference to FIG. 1, which is a perspective view of a lighting device 11. Lighting device 11 may have a tubular housing 13 which may include a first half 15 and a second half 17. Lighting device 11 may have a first end 19 and a second end 21. An expanded structure 23 may be attached to housing 13 at first end 19. Lighting device 11 is illustrated as having a slide knob selector switch 25 mounted to housing 13 adjacent first end 19 and a folding plug 27 mounted to housing 13 adjacent first end 19 and oppositely disposed from slide knob selector switch 25. Folding plug 27 is illustrated as extending away from housing 13 in an open position, although folding plug 27 may preferably be folded toward second end 21 of lighting device 11 into a closed position. An expanded structure 23 secures a lens 29 in place at first end 19 of lighting device 11. FIG. 1 further illustrates lighting device 11 as having a pull handle assembly 31 which is illustrated retracted a short distance away from second end 21 of housing 13 to illustrate additional structure. Pull handle assembly 31 remains attached to lighting device 11 by a cord 33. Pull handle assembly 31 may include a handle member 35 and a base member 37. Base member 37 may have a central opening 39 through which cord 33 passes. Base member 37 may support a pair of magnets 41, each of which may flank central opening 39. The magnets 41 can serve to assist in the secured orientation of the handle member as it is stored in the non-pulled position onto a flush position at the end of the housing 13. Handle member 35 may have an opening 43 by which handle member 35 can be more readily grasped and to facilitate pulling. The cord 33 is spring loaded to retract and the combination of the spring loading and the magnets 41 help return the pull handle assembly 31 back to a retracted stable position with respect to the housing 13. Opening 43 may also allow the lighting device 11 to be suspended, as by a hook on a wall or belt, for instance, for convenience when the lighting device 11 is being used portably. Handle member 35 includes a rim 44 around its circumference immediately adjacent base member 37.

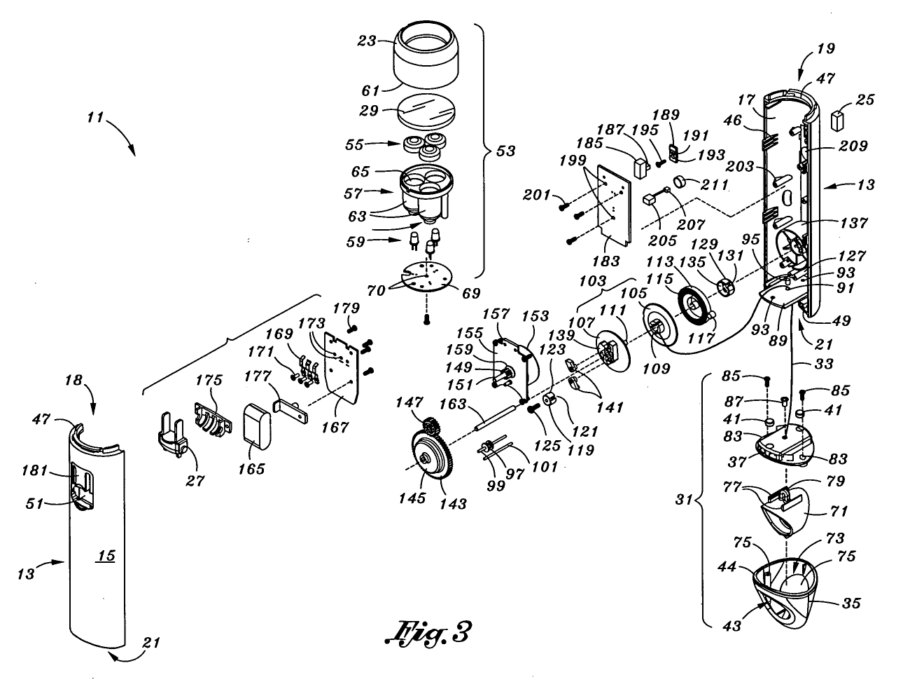

FIG. 2 is a view of the lighting device 11 of FIG. 1 and illustrates lighting device 11 shown adjacent a wall 44 and plugged into a power outlet 45 supported by wall 44. FIG. 2 illustrates tubular housing 13, lens expanded structure 23, slide knob selector switch 25, and pull handle assembly 31 including handle member 35. In FIG. 2, the lighting device 11 is illustrated as on and is illuminating the wall 44 and adjacent floor.

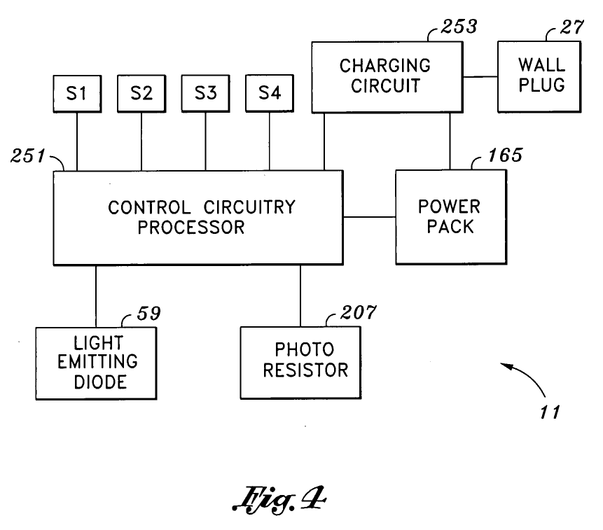

FIG. 3 is an exploded view of the lighting device 11 illustrated in FIGS. 1 and 2. FIG. 3 more clearly illustrates first half 15 and a second half 17 of tubular housing 13. Note that the overall shape of housing 13 is not limited to a tubular shape, but can be any one of a variety of sizes and shapes, such as square, rectangular, or spherical, for example. First half 15 and second half 17 may snap or glue together at prongs 46. When lighting device 11 is assembled, first end 19 of housing 13 may be joined by locking ring 47 and the edge of second end 21 may have a recessed ledge 49.

First half 15 of housing 13 may have a plug-shaped recess 51 near first end 19 into which folding plug 27 can be collapsed for convenience when the lighting device 11 is in use. Although folding plug 27 is illustrated here as having only two prongs, it is conceivable that folding plug 27 may have a third, grounding prong for increased support. Thus, folding plug 27 may be a three-prong plug or may have any other prong configuration which would allow the lighting device 5 to be plugged into a power outlet for charging.

Lighting device 11 is illustrated in FIG. 3 as having a lighting assembly 53 adjacent first end 19 of housing 13. Lighting assembly 53 comprises (in order of assembly from first end 19 toward second end 21) lens expanded structure 23 which may be a cap or other retaining structure, lens 29, plurality of convex lenses 55, a reflector base 57, and a plurality of light emitting diodes (LEDs) 59.

Lens expanded structure 23 may have a locking edge 61 which may be compatible with locking ring 47 at first end 19 of housing 13 to enclose lens 29, convex lenses 55, reflector base 57 and LEDs 59. Reflector base 57 may include a plurality of tubes 63, each of which may have by a first opening 65 and a second opening 67. When lighting assembly 53 is fully assembled, convex lenses 55 are seated in first openings 65 of each of tubes 63 of reflector base 57 and LEDs 59 which are preferably mounted on an LED printed circuit board (PCB) 69, may extend into second openings 67 of tubes 63 of reflector base 57 so that light will project from the LEDs 59 through convex lenses 55 and subsequently through lens expanded structure 23 when the lighting device 11 is illuminated. LED PCB 69 may include a plurality of screw holes 70 by which it may be attached to reflector base 57 for stability.

FIG. 3 more clearly illustrates pull handle assembly 31. FIG. 3 illustrates, in order of assembly from first end 19 of housing 13 toward second end 21 of housing 13, handle member 35, base member 37, and a reinforcing member 71 therebetween. Handle member 35 may include a recess 73 into which reinforcing member 71 is fittable. Handle member 35 may further includes a pair of screw receptacles 75, each of which may flank recess 73 and both of which may allow base member 37 to be securely fastened to handle member 35 to enclose reinforcing member 71.

Reinforcing member 71 may include a pair of ridges 77 and a hitch 79 to which cord 33 is secured. Base member 37 may include a pair of wedge-shaped stops (not illustrated) which extend just inside the space between ridges 77 in reinforcing member 71 to maintain ample space between reinforcing member 71 and base member 37 such that cord 33 is not impinged by hitch 79.

Base member 37 includes a pair of openings 83 into which a pair of screws 85 may be inserted to secure base member 37 to handle member 35 at screw receptacles 75. Eyelet 87 may fit inside central opening 39 of base member 37 to ensure that the integrity of cord 33 is minimally impacted when pull handle assembly 31 is actuated. Eyelet 87 may be made from any material which is compatible with the cord 33 to give minimum friction and wear.

Following the path of cord 33 in FIG. 3, cord 33 is shown as passing through a plate 89 through a central opening 91. Plate 89 may further include a pair of metal plugs 93 on either side of central opening 91 and which are constructed of a metal to which magnets 41 will be attracted for the purpose of keeping pull handle assembly 31 firmly seated on recessed ledge 49 at the edge of second end 21 of housing 13 when the pull cord 33 not in use. Eyelet 95 fits through the central opening 91 in plate 89 to protect the integrity of cord 33 as it passes back and forth through central opening 91. Linking pins 99 and 101 may be secured by a keeper 97 and operate with other structures to enable the pulling motion of the cord 33 to be translated into circular mechanical action.

Once the cord 33 passes through the central opening 91 of plate 89, it winds partially around a around a cord carriage 103, which comprises a first bracket 105 and a second bracket 107. A first set of projections 109 at the center of first bracket 105 extend perpendicularly away from the plane of first bracket 105 toward second bracket 107, and a second set of projections 111 at the center of second bracket 107 extend perpendicularly away from the plane of second bracket 107 toward first bracket 105. When the lighting device 11 is assembled, projections 109 and 111 fit together to form the center of cord carriage 103 around which cord 33 coils. When not being charged, cord 33 is coiled around cord carriage 103 and pull handle assembly 31 is seated adjacent second end 21 of lighting device 11. As the pull handle assembly 31 is actuated, cord 33 unwinds from cord carriage 103 such that cord carriage 103 is rotated.

Immediately adjacent and axially aligned with first bracket 105 of cord carriage 103 is a spiral torsion spring 113. Spring 113 has a central hub 115 and a peripheral eye-loop 117. A securing member 119 is axially aligned and adjacent to spring 113 and includes a slot 121 to allow securing member 119 to fit over eye-loop 117 of the spring 113 to hold the spring 113 in a fixed position relative to the second half 17 of housing 13. Securing member 119 may further include a central opening 123. As assembled, screw 125 passes through central opening 123 and subsequently through eye-loop 117 of spring 113 and into corresponding screw receptacles 127 in second half 17 of housing 13.

Shown immediately adjacent and axially aligned with spring 113 is an engaging member 129. Engaging member includes a slot 131 which allows the engaging member 129 to fit over the hub 115 of spring 113. A second set of projections (NOT ILLUSTRATED) at the center of first bracket 105 are axially aligned with first set of projections 109 on first bracket 105 and extend perpendicularly away from the plane of first bracket 105 in a direction opposite that of first set of projections 109. As engaging member 129 is fitted over spring 113, slot 131 catches hub 113 of spring 113. Engaging member 129 then engages with projections second set of projections 133 to link the cord carriage 103 with the spring 113. The underside of engaging member 129 includes a series of stops 135 to help prevent slippage and to facilitate translation of rotation from the cord carriage 103 to the spring 113.

On actuation of the pull handle assembly 31, cord 33 unwinds from and rotates cord carriage 103. Translation of the rotation of cord carriage 103 to spring 113 activates the spring 113. When the pull handle assembly 31 and cord 33 are released, the tension on the spring 113 is released, causing the cord 33 to automatically recoil around the cord carriage 103 to its neutral coiled position. Second half 17 of housing 13 includes a support structure 137 which lends lateral stability to the above described rotating parts. It should be noted here that, ideally, folding plug 27 should collapse only unidirectionally, for example toward pull handle assembly 31 or perpendicular to pull handle assembly 31 in either sideways direction to prevent unseating the lighting device 11 from a power outlet unintentionally when the pull handle assembly 31 and cord 33 are actuated.

A second set of projections 139 at the center of second bracket 107 extend perpendicularly away from the plane of second bracket 107 in a direction opposite that of first set of projections 111. Second set of projections 139 on second bracket 107 support a pair of clutch pawls 141 which engage with and turn a drive gear 143 as the cord carriage 103 rotates with each pull of the pull handle assembly 31 and cord 33. Drive gear 143 includes a cylindrical space 145, only the outside of which is seen in FIG. 3, into which clutch pawls 141 extend and selectively engage. Cylindrical space 145 may have a series of teeth, projections, stops or other structures around its inner circumference (not visible in this illustration) which enable the clutch pawls 141 to positively engage, without slippage, during rotation of cord carriage 103 in one direction to result in a ratchet-type rotation of drive gear 143.

Drive gear 143 intermeshes with an intermediate gear 147, which, in turn, intermeshes with a pinion 149. When pinion 149 is driven by drive gear 143 and intermediate gear 147, pinion 149 rotates a motor axle 151 which activates a generator, hereinafter referred to as a motor (the internal details of which are omitted for clarity) located in motor housing 153, which is mounted to support flange 155. Support flange 155 may include a plurality of openings 157 by which support flange 155 can be secured to housing 13 using screws 159. Support flange 155 supports a shaft 161 on which intermediate gear 147 rides. A main axle 163 supports drive gear 143, cord carriage 103, spring 113 and engaging member 129 when the lighting device 11 is assembled. Activation of the motor by actuation of the pull handle assembly 31 and cord 33 results in generating the power necessary to incrementally charge a built-in power pack 165 which may be a capacitor, or rechargeable battery or some other device or a hybrid power pack. Power pack 165 and plug 27 are mounted on a support 167. Contacts 169 are mounted to support 167 and are illustrated as being fitted with members 171. Support 167 includes a plurality of small openings 173 by which a plug cradle 175 and power pack bracket 177 may be mounted to support 167 using screws 179. Plug-shaped recess 51 includes an opening 181 through which plug cradle 175 extends to support folding plug 27 when the lighting device 11 is assembled.

FIG. 3 illustrates a switch PCB 183 adjacent and slightly offset from support 167. Adjacent switch PCB 183 is a sliding switch 185 which is mountable to switch PCB 183. Sliding switch 185 has a projection 187 which extends through a cover plate 189 via a first opening 191 in cover plate 189 when the lighting device 11 is assembled. Cover plate 189 includes a second opening 193 which allows it to be attached to the underside of slide knob selector switch 25 by passing a screw 195 through a slot 197 in second half 17 of housing 13. Switch PCB 183 includes a plurality of openings 199 by which it may be attached to second half 17 of housing 13 using screws 201 and corresponding screw receptacles 203.

Also illustrated adjacent switch PCB 183 is a bracket 205 which can support an adjacent photo sensitive device 207. Second half 17 of housing 13 further includes an opening 209 over which a light-permeable cap 211 is positioned. Light-permeable cap 211 seals opening 209, yet still allows light to be transmitted through opening 209 to photo sensitive device 207.

Slide knob selector switch 25 allows a user to control the operational mode of lighting device 11. Slide knob selector switch 25 has at least four possible positions: a first OFF position, a second ON position, a third NIGHT LIGHT MODE position, and a fourth EMERGENCY LIGHT MODE position. The third and fourth positions can be optional depending upon whether one or both or none of the special features are desired. In the OFF position, the lighting device 11 is not illuminated and will revert into and out of a self-charge mode as needed. In the ON position, the lighting device 11 will be switched on all the time and which can be used as a 24 hour per day always on wall mounted light as well.

When slide knob selector switch 25 is in the NIGHT LIGHT MODE position, photo sensitive device 207 is activated and receives light input through photo sensitive device cap 211. Relay circuitry is then activated such that, when photo sensitive device 207 detects daylight, the lighting device 11 turns off automatically. Likewise, when photo sensitive device 207 detects darkness, the lighting device 11 turns on automatically. If lighting device 11 is being used in NIGHT LIGHT MODE and is being stored plugged into a power outlet, it can provide uninterrupted light throughout the nighttime hours without any effort on the part of the user.

When slide knob selector switch 25 is in the EMERGENCY LIGHT MODE position, current detecting circuitry receives input such that interruption of current (as occurs with loss of power) activates illumination of the lighting device 11. In the absence of power from the AC mains, the lighting device 11 will continue to illuminate the dark areas as the stored power is depleted. However, the lighting device 11, without even having removing it from its wall support from a power outlet 45 charge the lighting device 11 by hand using the pull handle assembly 31 and cord 33 as described above. In this configuration, a number of the lighting devices 11 can be used to illuminate hallways and exit paths, with intermittent re-charging by a responder.

Assuming that the lighting device 11 is stored as plugged into a working power outlet, lighting device 11 will self-charge regardless of the position of slide knob selector switch 25 and will cease charging once the power pack 165 is fully charged. This self-charge feature relieves the user from continually having to think ahead to change or charge the batteries.

Referring to FIG. 4, a block diagram illustrates one possible configuration of the components within the lighting device 11. The slide knob selector switch 25 is represented in block diagram form as a series of switch position blocks S1, S2, S3 and S4, which correspond with the positions “off”, “on”, “emergency illumination light”, and “night light” which have been previously described. The switch position blocks S1, S2, S3 and S4, connectot a CONTROL CIRCUITRY PROCESSOR block 251 in which switch selection and a variety of other monitoring and computational tasks may occur. The CONTROL CIRCUITRY PROCESSOR block 251 is connected to the power pack 165, and the power pack 165 is shown as being connected to a CHARGING CIRCUIT block 253. It is clear that the CONTROL CIRCUITRY PROCESSOR block 251 and CHARGING CIRCUIT block 253 could be formed as one common circuit or even use a common microprocessor or controller chip. In the configuration shown, the emphasis is operational, namely that anytime that the wall plug 27 receives power into the CHARGING CIRCUIT block 253, the power pack 165 will automatically be under charge. In addition to the connection between the CHARGING CIRCUIT block 253 and the power pack 165, an optional connection is shown between the CHARGING CIRCUIT block 253 and the CONTROL CIRCUITRY PROCESSOR block 251 so that the CONTROL CIRCUITRY PROCESSOR block 251 will have instant access to a state of failure of the energization of the wall plug 27.

Also shown connected to the CONTROL CIRCUITRY PROCESSOR block 251 is the photo sensitive device 207. All of the aforementioned inputs to the CONTROL CIRCUITRY PROCESSOR block 251 enable it to control the light emitting diode 59 throughout all of the “off”, “on”, “emergency illumination light”, and “night light” modes of control described.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A multi-function, manually chargeable lighting device comprising:
a housing;
a power pack;
a collapsible ac mains power plug member supported by said housing and connected to power said power pack;
a charging motor;
at least one light-emitting diode;
a pull cord having a first end and a second end;
circuitry connecting the motor, the power pack and the at least one light-emitting diode;
and wherein the pull cord is mechanically linked to the motor such that actuation of the pull cord causes the motor to generate electricity to the power pack for energizing the at least one light-emitting diode.

2. The lighting device as recited in claim 1 and-further comprising:
a charging circuit having an alternating current input from a wall AC outlet through the power plug, and having a direct current output to the power pack for charging the power pack.

3. The lighting device as recited in claim 2 wherein the power plug can support said manually chargeable lighting device from an AC mains outlet.

4. The lighting device as recited in claim 2 and further comprising:
means, associated with the circuitry, for initiating the energization of the at least one light-emitting diode upon loss of power to the charging circuit.

5. The lighting device as recited in claim 4 wherein said means for initiating the energization of the at least one light-emitting diode upon loss of power to the charging circuit includes at least one of a voltage and a current detector.

6. The lighting device as recited in claim 4 and further comprising:
means, associated with the circuitry, for initiating the energization of the at least one light-emitting diode in low-light conditions.

7. The lighting device as recited in claim 6, and wherein the means for initiating the energization of the at least one light-emitting diode in low-light conditions includes a photo sensitive device.

8. The lighting device as recited in claim 6 and further comprising a manually controllable switch, associated with the circuitry, for enabling manual control of circumstances of energization of the at least one light-emitting diode.

9. The lighting device recited in claim 8 wherein the switch is moveable between at least a first off position, a second on position, and a third AC mains power interrupt position.

10. The lighting device as recited in claim 9 and further including a fourth low room light night light position wherein the light-emitting diode is energized in low-light conditions.

12. The lighting device as recited in claim 1 and further comprising:
a handle attached to one of said first and second ends of said cord to facilitate ease of actuation of the cord.

13. The lighting device as recited in claim 12 wherein the motor is actuated by pulling said cord away from said housing and wherein said cord automatically retracts into said housing upon release.
